(19) United States
(12) Patent Application Publication
(10) Pub. No.: US 2010/0269157 A1
(43) Pub. Date: Oct. 21, 2010

(54) System and Method for User Control of Authorizing and Tracking Access to Electronic Records

(76) Inventor: Bettina Experton, Del Mar, CA (US)

Correspondence Address: JEFFREY PEARCE, 34825 SULTAN-STARTUP RD., SULTAN, WA, 98294, US

(21) Appl. No.: 12/763,209

(22) Filed: Apr. 20, 2010

Related U.S. Application Data
(60) Provisional application No. 61/171,016, filed on Apr. 20, 2009.

(51) Int. Cl. G06F 21/00; G06F 15/173; H04L 9/32; G06F 15/16

(52) U.S. Cl. 726/4; 709/223; 726/28; 709/206; 709/223

(57) ABSTRACT

A record holder accesses a coordinating server via a network. The coordinating server either itself stores or communicates electronically with one or more other servers that store electronic records (ER), including at least some associated with the record holder. Third-party record recipients are also connected via the network to the coordinating server and possibly also to the ER server(s). The user accesses the coordinating server, selects at least one of the recipients and specifies which of the electronic records, or portions thereof, that the user wishes that particular recipient to be able to access, possibly along with other access right parameters such as an access time or period. The recipient then accesses the coordinating server and/or one of the ER servers to retrieve electronic records of interest, which are made available according to the access rights and limitations pre-set by the user.

### CROSS-REFERENCE TO RELATED APPLICATIONS

This application claims priority from U.S. Provisional Patent Application 61/171,016, filed 20 Apr. 2009.

### BACKGROUND ART

In today's society, individuals typically hold multiple electronic records which they need/wish to share with others, and more specifically with service providers whose access to those records would help them deliver better service to these individuals. Even where these records are web-accessible, two challenges arise. On the one hand, individuals often need to be able to easily retrieve records from any point-of-service location, even where these records are stored in different places. On the other hand, for privacy and security reasons, record holders need to be able to authorize and control who is accessing, viewing, and editing these records once they have been retrieved.

This difficulty to both easily retrieve as well as control access/use of these personal electronic records at the point-of-service in a timely manner (preferably in real-time), is particularly important in health care, where real-time access to individual electronic health records maintained by different health care providers, at the point-of-care, is necessary to provide a high quality of care and also to avoid duplication of services, which could be harmful to the patient and costly to all involved (the provider, insurer, and patient). No less important is the need to maintain individual records' privacy by allowing the individual record holder to control and restrict access and use of his/her records, and user-selected portions of these records, to the provider(s) of his/her choice.

Several systems are known that allow users to use some portable electronic device to access remotely stored electronic records, including some form of security procedure such as a password-based log-in. These systems are in general immediate and direct, such that requested information is then downloaded immediately and directly to the device of the user that just made the record access request, or to some device or computer to which the user's portable access device is connected. This is not always convenient or even suitable when third-party authorized access is what's needed.

### BRIEF DESCRIPTION OF THE DRAWINGS

FIG. 1 is a block diagram of the main system components of an embodiment of the invention.

FIG. 2 illustrates not only an example of electronic records, but also an optional record aggregation and summarization procedure.

### DESCRIPTION OF THE INVENTION

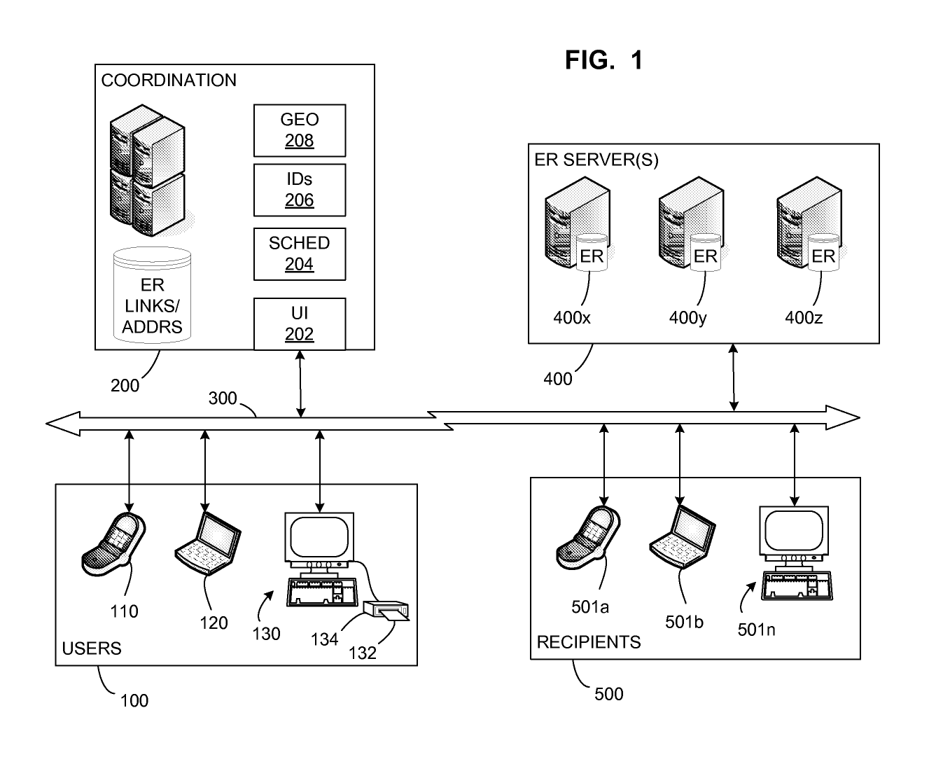

FIG. 1 illustrates the general system configuration of the invention: Using a network access device or system 100, a record holder accesses a coordinating server 200 via a network 300. The coordinating server, which includes various modules 202, 204, 206, 208 of computer-executable code for performing respective functions, either itself stores or communicates electronically with one or more other servers 400 (400i, . . . 400j) that store electronic records (ER), including at least some associated with the record holder.

A group 500 of record recipients, each represented by a record-viewing system 501a, 501,b, . . . , 501n (although of course they may share or have more than one each) is also connected via the network 300 in any conventional manner to the coordinating server 200 and ER server(s) 400 (whose functions and data may in some implementations be incorporated into the coordinating server 200 itself, as explained below). In FIG. 1, the recipients are shown as using different types of record-viewing systems, including mobile telephones, netbook or tablet computers, and stand-alone computers, merely to illustrate that this is possible in the invention. The recipients do not need to be using the same devices to view records as the users use to authorize viewing. Also, the coordinating server 200 is shown as having a user-interface module 202, which will be programmed using known techniques to present and/or communicate with the user interfaces of the various input devices 100.

The general method of the invention is that the user accesses the coordinating server, selects at least one of the recipients in the group 500, and specifies which of the electronic records, or portions thereof, that the user wishes that particular recipient to be able to access, possibly along with other access right parameters such as an access period and other user preferences. Via one of the record-viewing systems, the recipient then logs into or otherwise accesses the coordinating server 200 and/or one of the ER servers 400 to retrieve electronic records of interest, which are made available according to the access rights and limitations pre-set by the user. Different devices, procedures, and options may be used to implement these various components and functional steps.

The network access device or system 100 may, for example, be issued by the user's insurer, the government, the user's primary health care provider system, an electronic records solution provider, etc. The device or system 100 (used as a collective reference number for the sake of succinctness and convenience) may be unitary and essentially self-contained, or comprise separate sub-systems. One example of a unitary system is a web-enabled telephone 110, PDA, tablet computer, netbook, 120, etc., that allows the user to access networks such as the Internet, enter and receive both graphical and/or textual data and information and to interact with servers at specified addresses such as, for example, URLs.

Examples of non-unitary access systems include hand-held devices 132 with a memory and preferably an embedded microprocessor or otherwise programmable chip, such as smart cards, USB flash drives (for example, drives that include software that can auto-launch upon insertion of the drive into a computer's 130 USB port, or that can be launched manually), as well as “non-intelligent” devices such as cards with magnetic and optically readable portions, RFID cards, etc. Such devices may for example be inserted into an appropriate internal or peripheral reader or sensor 134 of the computer 130 and thereby either launch associated software, or act as both authentication and basic data entry devices, possibly including a portal address to the coordination server or even address identifiers for the remote network locations of relevant electronic records.

In some implementations, the network access device or system 100 will need to be initialized by the user. For example, upon first use of a device such as a USB flash drive or smart card 132, the user may be instructed to insert it into or otherwise connect it into the appropriate reader 134 of a computer. Either the device itself or the computer may then launch an application that establishes the user's connection parameters with the coordinating server 200. These will typically include a user name and password, which may be supplied to the user by whatever entity issued the access device. Either the user, manually, or a software application resident on the device itself or in the computer then follows normal procedures to connect to the coordinating server 200 via the network 300 and complete some initial administrative procedures to authenticate the user and establish a personalized “account.”

In implementations that use unitary or self-contained devices 100, there may be no need for any readers at all, but rather the authentication and access software may be included in the device itself, such as an application in a web-enabled telephone. In such case, the user may establish a connection to the network in whatever manner the telephone uses, launch the application, connect to the coordinating server 200, and manually or automatically complete whatever authentication and access procedure the system administrator will have implemented. This will usually include entering a user name and password as in other cases.

By way of example only, the configuration and method of operation of various aspects of the invention are described below with primary reference to an implementation in which a patient wishes to authorize but control access to his electronic health records (EHR) by various health-care providers. Other uses are of course possible, such as a user wishing to grant and control access to his financial records by representatives of various financial and credit institutions; students wishing to grant and control access to their educational records by others; members of human resources departments of companies who wish to granted limited access to employees' employment records to others in the companies; etc. To the extent modifications to the system and method of the invention described here will be needed at all to accommodate such other uses, these will be well within the skill of those in the field of programming servers, computers, and devices such as web-enabled telephones.

Assume that a patient/user wishes to grant access to certain of his medical records to a physician, with whom he has an appointment at a known time and date. In this example, the patient/user will use a web-enabled telephone. He therefore launches an application, for example, simply by touching an on-screen icon, whereupon the application, according to known routines and in cooperation with whatever operating system is included in the telephone, then loads and executes and connects via the Internet to the coordinating server 200. If not already part of the installed phone application, the server 200 then returns or activates code within the telephone to cause the display of an initial screen, for example, to allow the user to enter any required user name and password to begin an access authorization session, assuming that this log-in procedure is not automated.

Once the user has been authenticated and the session has started, the user may be presented with any desired administrative information or requests and other choices. Of greatest relevance to the invention, however, is that the user should be able to indicate to the coordinating server 200 that he wishes to enable some service provider, in this example, a health-care provider, to be able to access some of his electronic health records, but not to records relating to treatments for a past mental health issue.

Although it would be possible to allow a user to grant access to all enrolled providers in the system, for example during some specified time window, in most cases the patient will want to specify a particular health-care provider to be authorized record access. The coordinating server 200 will therefore typically have some unique identifier stored in an appropriate database or file 206 for each of the health-care providers enrolled in the system, along with information such as, for example, an email, other network address, telephone number, etc., to which user-authorized records can be sent or made accessible for viewing. The user should also be able to uniquely identify the chosen record recipient for the coordinating server 200.

There are many ways for a user to identify the health-care provider who is to be authorized access to records and the one actually chosen in any given implementation of the invention will depends on the preferences of the overall system administrator. One way is for the coordinating server 200 to present to the logged-in user a pull-down list of enrolled health-care providers and others, possibly categorized by specialty, location, etc. to limit the size of the list. To initially limit the size of the list, the user could also be required first to enter some geographical information such as a postal code or city name, specialty, etc. The user may then select the intended health-care provider from the list.

One potential problem with a simple pull-down list is that there may be more than one enrolled health-care provider with the same or confusingly similar name in the same city, or even in the same hospital or medical center. Other methods may therefore be used to avoid ambiguity. For example, instead of or in addition to a name, the user could enter an identifier of the health-care provider, for example, a medical license number or an identifier assigned by the system administrator. The user could get this identifier from the health-care provider's office at the time of making an appointment, or from a catalog of enrolled health-care providers, etc. Other identifiers such as an email address could of course also be used, depending on the level of security and certainly one wants the authorization system to have.

Another option would be for the health-care provider's office to give the user an appointment confirmation code when the user makes the appointment. This code could itself uniquely identify the health-care provider herself, and/or could also be used to identify the appointment if the coordinating server 200 is configured to include a scheduling routine 204 and database into which the health-care provider's office could input information about appointments. The patient/user could then input the appointment confirmation code, which the coordinating server 200 could then associate with the health-care provider's scheduling entry and thus also with the correct health-care provider.

After the patient/user has once identified a recipient health-care provider, then the identifier for that health-care provider may be stored in a “recently” or “previously” authorized list so that the user can more easily find and select that health-care provider on future occasions.

Once the patient/user has established for the coordinating server 200 which health-care provider is to be authorized to receive or view electronic records associated with the patient/user, according to one aspect of the invention, the user may also be allowed to specify which records or portions of records are to be permitted/restricted, and also—if implemented—to specify at what time the authorization begins and ends.

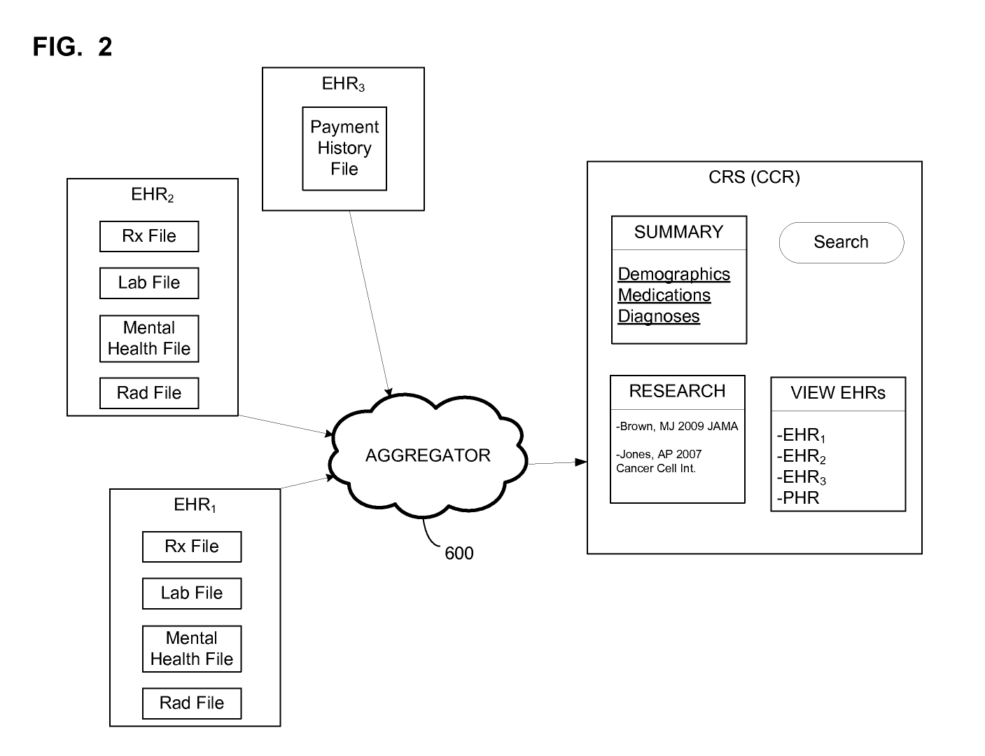

The coordinating server 200 therefore may present to the patient/user any known textual or graphical display that enables the patient/user to designate electronic records for viewing by the chosen health-care provider. As FIG. 2 illustrates, just a few examples of possible records include not only those identifying the patient/user, but also data relating to laboratory results, past and present medications and current prescriptions, records of hospital admissions, records relating to outpatient treatments for mental health-related and other issues, radiology reports, and information relating to insurance and/or payment history.

The coordinating server 200 may allow the patient/user to select or deselect records in any conventional manner. For example, they could be listed with check boxes, or indicated graphically for selection, or could be added to an approved list upon selection from a pull-down menu, or using any of the other common methods by which users indicate selections to a server through a network. Some records, such as those identifying the patient/user himself, may be assumed to be authorized, whereas rules may be established in the coordinating server 200 such that some other types of records are never allowed to be submitted to particular recipients or types of recipients. For example, the records that can be opened to a pharmacist, for example, might be restricted to always exclude radiology reports, which may be deemed irrelevant, but records indicating allergies may be designated such that the patient/user *must* authorize them if any other authorization is given to the pharmacist recipient.

It would be possible to implement the invention so as to allow “one-time-for-all” authorization of records for all of some particular health-care provider/recipients, but in most implementations of the invention it will usually be preferable to “open” access only after or during some time.

According to one optional aspect of the invention, the coordinating server 200 presents the patient/user with an entry screen in which he can specify the time of the appointment for which the record access is to be authorized, or set a start and/or ending time for access.

One alternative to requiring the user to pre-set an authorization time would be to have the user send a command, for example, using the same network access device 100 he used to set up the authorization, at the time when access is to be initiated on behalf of the recipient. In other words, the patient could initiate access when he is in the doctor's office. The user could then similarly stop access with a different command.

As a back-up for cases where the user is not able to access the network and coordinating server 200 to open access to EHRs (if this isn't set to happen automatically, for example, on a schedule), then the system administrator could also establish a regular telephone number that the user can call to start access. For example, at the time the authorization session is completed correctly, the coordinating server 200 could issue a confirmation code to the user. Entering this confirmation code via a normal telephone connection, along with a password or PIN of the like could then signal to the coordinating server 200 that it should open access to the EHRs. The technology to implement such call-in confirmation to a server is known, for example, to those who activate credit cards by telephone.

Yet another alternative method of activating authorized access by a selected health-care provider may be based on geo-location: Using the GPS feature increasingly included modern web-enabled, the coordinating server 200 could include a position-sensing feature and corresponding software module 208 that receives and processes position information from users' phones (or similar devices) and either automatically activates authorized access when a user is within a given distance from the known position of the authorized health-care provider's office, or accepts a “Send” command from the user when he is within that distance.

In implementations where the user/patient interacts with the coordinating server 200 via a web-enabled telephone or similar network-connected device, the time for authorized access is preferably entered as a calendar event in the calendaring application typically found in such devices. The device 100 could then give a reminder alarm to the user either at the time when access is to take place, or needs to be initiated, or at some set time beforehand.

The application in the user-controlled access device 100, and suitable programming in the coordinating server 200 may also be arranged to allow convenient rescheduling of EHR access. For example, the user could log back into the coordinating server 200, select from a list of scheduled access authorizations, and re-enter the relevant times. Where the device is a self-contained, portable system that has the access as a scheduled calendar event, it would also be possible to allow the user to change the access time when the system gives the reminder alarm. Any change entered at that time by the user could then be pushed to the coordinating server 200, which updates its own scheduling data accordingly.

The coordinating server 200 may have different degrees of “responsibility.” One option is that it handles administrative tasks such as communicating with the users and record recipients, maintains data indicating record authorizations and times, creates and maintains an access log, etc., but does not itself store any records. In this case, the coordinating server 200 could store only addresses/links to records, or only to a different server that maintains either the record addresses/links, or these along with some or all of the records that can be processed. It would also be possible for the user's own device or system 100 to contain all necessary links and addresses, which the coordinating server 200 then retrieves upon user log-in and confirmation of a requested access authentication. In applications where the user is a patient and record recipients are to be health-care providers, the coordinating server 200 would thus function as a Health Information Exchange (HIE) portal.

Once the specified, authorized records are “open” for access by the chosen health-care provider, different methods may be used to make the records available to the health-care provider. One method is that the coordinating server 200 “pushes” the records to the health-care provider at the access time, for example, to a pre-designated email address. In some cases, the EHRs that the health-care provider/recipient is authorized to access may be small enough, or arranged in a such a format, that they can be sent as a telephone text message (for example, sms). These methods relieve the health-care provider of all need to do anything other than check her email or text message inbox at the appropriate time. It would also be possible, however, to require the health-care provider to log into the coordinating server 200 or some other designated site to receive the records.

Yet another alternative would be for all electronic records provided via the coordinating server 200 to be made “view only” for the health-care provider in the authorized time slot, especially if access to the records is made using dedicated installed software.

Records may be presented to authorized recipients in different formats, depending on the given implementation of the invention. One option is to display the different electronic records “as is,” that is, as individual, distinct records in the format used and originating from the distinct record issuers and stored in the different systems 400x, 400y, . . . , 400z.

Another option, illustrated in FIG. 2, is to create an aggregated record summary, such as a clinical record summary including the individual data emanating from the distinct records and aggregated in a pre-agreed format for use by different types of providers (physicians, pharmacist, imaging centers, etc.) for different users, using or not using standards such as Continuity of Care Records/Documents” (CCR/CCD) and other standards.

An aggregator service or application 600 such as provided by the companies Google or Kosmix may be used to create such clinical record summaries (CRS), which may be presented to authorized recipients either instead of or in addition to “as is” presentations. As FIG. 2 illustrates, different EHRs (EHR₁, . . . , EHR₃) may be aggregated into a convenient format CRS, which may include a summary of particularly relevant information, links or actual files show the authorized EHRs, a search routine, and possibly other helpful information such as links to relevant research reports or clinical practice guidelines, government regulations, etc. Such other information could, for example, be stored by the health-care provider as a result of previous appointments.

It is usually desirable to be able to track the access and use of individual electronic health records over time and to allow this track to be retrievable at any time to protect individual privacy by checking on privacy breaches, and identifying privacy violators. Such tracking also allows for proper monitoring of optimum use of electronic health records to improve the quality of care, monitor health care costs, and evaluate the cost-effectiveness of new healthcare IT investments. Because the coordinating server 200 functions as a central point of contact for both authorizing access to records by the user as well as for presenting records to authorized recipients, the invention enables easy tracking of all record accesses simply by storing in a database the information relating to each authentication session.

I claim:

1. A method for processing and coordinating access to electronic records of a user comprising, in a coordinating server:
receiving, via a network, a record access authorization request from a network access device of the user, including a user-specified indication of which of the electronic records, in whole or in part, are to be made accessible by a user-selected, third-party recipient; and
making the user-specified electronic records available to the user-selected, third-party recipient.

2. The method of claim 1, further comprising:
receiving, as part of the record access authorization request, a user-specified record access time; and
making the user-specified electronic records available to the recipient only according to the user-specified record access time.

3. The method of claim 2, further comprising making the user-specified electronic records available to the recipient at the user-specified record access time, without further action on the part of the recipient.

4. The method of claim 1, further comprising making the user-specified electronic records available to the recipient only upon sensing a subsequent access initiation signal from the user.

5. The method of claim 4, further comprising sensing the physical location of the user by receiving geo-location data from the user's network access device, in which the initiation signal is proximity of the user to the recipient.

6. The method of claim 4, in which the initiation command is a signal from a mobile network access device selected from the group comprising a mobile telephone, a web-enabled mobile telephone, and a portable, network-connected computer.

7. The method of claim 1, further comprising maintaining in the coordinating server network addresses and links to the electronic locations of the user's electronic records, which are stored in separate servers.

8. The method of claim 1, further comprising aggregating the user's electronic records and converting them into a predetermined presentation format before making them available to the third-party recipient.

9. The method of claim 1, further comprising:
receiving a record access request by the user-selected, third-party recipient; and
making the user-specified electronic records available to the user-selected third-party recipient only upon receipt of the record access request.

10. The method of claim 1, further comprising making the user-specified electronic records available to the user-selected third-party recipient by pushing them from the coordinating server to a predetermined network location of the recipient.

11. The method of claim 10, in which the predetermined network location of the recipient is an electronic mail (email) account.

12. The method of claim 10, in which the network connecting the coordinating server and the recipient is a mobile telephone network, further comprising converting the electronic records into a text-messaging format for viewing on a mobile telephone of the recipient and making the user-specified electronic records available to the user-selected third-party recipient by transmitting the electronic records as a mobile telephone text message.

13. The method of claim 1, further comprising storing the user's electronic records in the coordinating server itself.

14. The method of claim 1, in which the coordinating server makes the user-specified electronic records available to the user-selected, third-party recipient without any other action on the part of the third-party recipient other than accepting access to the corresponding user's electronic records.

15. A system for processing and coordinating access to electronic records of a user comprising a coordinating server that is connected to a network for receiving a record access authorization request from a network access device of the user, including a user-specified indication of which of the electronic records, in whole or in part, are to be made accessible by a user-selected, third-party recipient; and for making the user-specified electronic records available to the user-selected, third-party recipient.

16. The system of claim 14, in which the network access device of the user is a web-enabled mobile telephone.

17. The system of claim 14, in which the coordinating server further includes a scheduling module comprising computer-executable instructions for making the user-specified electronic records available to the recipient only according to the user-specified record access time.

18. The system of claim 14, in which the coordinating server further includes a database maintaining network addresses and links to the electronic locations of the user's electronic records, which are stored in separate servers.

19. The system of claim 14 , in which the coordinating server is further provided for receiving geo-location data from the user's network access device and for making the user-specified electronic records available to the user-selected, third-party recipient only when the user is in proximity to the recipient.
